(19) United States
(12) Patent Application Publication
(10) Pub. No.: US 2008/0021715 A1
(43) Pub. Date: Jan. 24, 2008

(54) System and method for analyzing and comparing cost increases

(75) Inventors: Stuart Alderoty, Rumson, NJ (US); Mark Lyman LoSacco, Monroe Township, NJ (US); Laura Karen Bass-Penn, Coram, NY (US); Todd Robert Miller, Hoboken, NJ (US); Odalys Arbelaez, Davie, FL (US)

Correspondence Address: FITZPATRICK CELLA (AMEX), 30 ROCKEFELLER PLAZA, NEW YORK, NY, 10112, US

(73) Assignee: AMERICAN EXPRESS TRAVEL RELATED SERVICES COMPANY, INC., New York, NY (US)

(21) Appl. No.: 11/487,989

(22) Filed: Jul. 18, 2006

(51) Int. Cl. G06Q 10/00; G06Q 30/00

(52) U.S. Cl. 705/1

(57) ABSTRACT

A method of analyzing and comparing changes in costs between a first and a second time period includes a first step of receiving cost data for the first time period and cost data for the second time period, a second step of calculating data representing a change in cost from the first time period to the second time period, based on a difference between the cost data for the first time period and the cost data for the second time period, and a third step of outputting the data representing the change in cost from the first time period to the second time period. The cost data represents a cost of a commodity purchased or to be purchased during a given time period. The cost data may also be compared with comparative data.

### BACKGROUND OF THE INVENTION

1. Field of the Invention

The present invention generally relates to systems and methods for analyzing and comparing cost increases, and in particular to such systems and methods for analyzing and comparing increases in prices or billing rates for goods and/or services charged by vendors.

2. Related Art

Currently, a corporation or other organization may spend significant amounts of money on purchases of commodities from external vendors (the term “commodity” is used herein to mean a good or a service). Law firms represent one type of external vendor which charges relatively high fees for its services and hence may account for a significant share of an organization's expenses. In view of budgetary pressures to keep expenses to a minimum, there is a need for an effective method and system for controlling expenditures, in particular, for expensive commodities purchased in significant amounts.

One particular problem in controlling such expenditures is that while a purchaser may believe that the nature of a given commodity it regularly purchases does not change, yet the price for the commodity charged by the vendor may increase periodically over time, for example, due to inflation or other factors. Because the commodity itself does not noticeably change, the purchaser may not expect price changes and hence may not monitor purchases of the commodity to keep track of the price actually being paid. Consequently, the purchaser may not be aware of price increases in such a commodity. As an example, where a purchaser continues to buy a commodity at regular intervals over a long period of time, the vendor may increase the price periodically (e.g., annually), without expressly notifying the purchaser of the price increases. Thus, bills submitted by the vendor in automated fashion to the purchaser may reflect such price increases but without providing any express notification to the purchaser of the fact of the price increases or the amounts of the price increases. Where a purchaser does not have in place a system to monitor the vendor's invoices for price increases, the purchaser may fail to notice such price increases and hence be unable to take action to mitigate them.

While a system for monitoring invoices for price increases so as to be able to alert the pertinent decision maker(s) within the purchasing entity of the price increases is the first step in a program to control, limit and manage price increases, it is not in itself sufficient. Even if the decision maker is notified of the price increases, the information is likely to come to the decision maker's attention in piecemeal fashion, as disjointed fragments of information. For example, a law firm may increase its billing rates for certain attorneys who perform work for the purchasing entity and not for others; among different law firms all hired by the purchasing entity, some may increase their rates while others do not; rate increases by different vendors may occur at different times, etc. Moreover, where the decision maker charged with approving or rejecting a vendor's price increase is apprised merely of a percentage or dollar amount of the increase per unit of the commodity (e.g., an increase of $50.00, or of 10%, per billed hour, in the case of a law firm vendor), the decision maker is not able to make a rational decision unless such price increase data is converted into data representing the ‘big picture’. That is, the price increase data will be more useful if converted or projected out to provide the actual quantitative effects thereof on a large scale, or rather on an appropriate set of various larger scales. What is wanted is the measured, quantified effect of the price increase with respect to amounts of the commodity purchased that are of significance to the purchasing entity, e.g., the effect the price increase will have on the purchasing entity's overall budget per annum (e.g., the increase in cost of the coming year's supply of the commodity, relative to the cost of the previous year's supply), the effect the price increase will have on the purchasing entity's budget for given subentities (e.g., departments or subsidiaries) per annum, the effect the price increase will have on the purchasing entity's budgets for given projects, matters (e.g., litigations), or the like (e.g., the increase in cost of the (estimated) number of hours required to work on the project, litigation, etc., relative to the cost of the same number of hours prior to the price increase), and so on. Such large-scale effects on the purchasing entity's budgets would desirably be provided to the decision maker in both absolute and percentage terms. Thus, there is a need for information regarding price increases to be organized and aggregated. The purchaser needs a system in place, not merely to monitor price increases, but to properly quantify them on larger scales of significance to the purchaser. Aggregation at both the global or overall level and also at other sublevels of interest to the purchasing entity, such as exemplified above, is generally desired.

In addition to translating discrete price increases into large-scale quantitative effects (aggregated at desired levels of analysis) on global, departmental or project budgets, or the like, the price increase data needs to be contextualized in respect of the market of competing vendors in order for it to serve as the basis of fully informed decisions concerning expenditures. Thus, comparative data representing the prices of the commodity charged by other vendors is required. Such comparative data should take into account the extent to which other vendors are situated similarly to the vendor in question. Thus, comparative data may be desired comparing a given vendor (e.g., law firm) with others located in the same region/city, with others of the same size, with others providing the same type of commodity (e.g., the same type of legal services), etc.

In addition to comparative data in respect of the market in general, comparative data in respect of the other vendors hired by the purchasing entity (for similar work) may be desired in order to provide a more realistic comparison, more suitable to the given purchasing entity because more representative of the particular type, style, level, etc. of law firm or other vendor desired to be hired by the purchasing entity.

To be sure, data comparing different commodities (e.g., legal services) provided by a single vendor, if applicable, would also be useful, to be evaluated in light of the relative value yielded by such different types of legal services (e.g., tax savings generated by tax legal services, patent royalties generated by patent legal services, etc.).

Thus, going beyond the steps of monitoring/notification and quantification at desired levels of analysis (organization and aggregation), the contextualization provided by comparative analysis (of a variety of types such as explained above) would permit price increases to be evaluated with even greater rationality. While quantification would permit evaluation in terms of a framework internal to the purchasing entity, i.e., in terms of the feasibility (affordability) on the part of the purchasing entity, comparative analysis would permit evaluation in terms of a framework external to the purchasing entity, i.e., in terms of reasonableness of the cost in view of objective market conditions.

Of course, in order to make sound decisions concerning expenditures, it is necessary that consistent metrics or methodologies be employed in performing such quantitative and comparative analyses. For example, when it comes to quantification, all price increases should be converted into the same units, e.g., increase in dollars/year. As for comparative analysis, for example, a given vendor whose price increases are under analysis should be compared with other vendors that are situated similarly in respects pertinent to the purpose at hand.

While perfect rationality in budgetary decision making may not be possible for a variety of reasons, such as the inability to measure and quantify the value generated by different types of, e.g., legal services competing for a piece of the purchasing entity's budgetary pie, still the rationality of budgetary decisions could be increased by making evaluations based on the results of such quantitative and comparative analyses. However, that is not the sole advantage that could be achieved by such analyses.

More fundamentally, such analyses would permit the purchaser to change the very terms of budgetary decisions to its advantage vis à vis the vendor. That is, the purchaser would be given greater control to change the options among which its decisions need be made. The reason for this is that the output provided by such quantitative and comparative analyses consists of focused, objective data that the purchaser could use as leverage in negotiating reductions in the vendor's proposed rate increases.

In sum, once the framework of quantitative and comparative analysis set forth above is put into place, price increases could be systematically and properly evaluated, so that rational decisions could be made as to their approval or rejection and crucial information, both as to the effect on the purchasing entity and as to the comparative market context, could be marshaled as leverage for the purchasing entity to negotiate reductions in price increases with vendors. In this way, such a framework would serve to improve cost performance and facilitate budgetary management. Such a framework may be understood as part of a larger process of organizational management and decision making with respect to purchasing/spending/budgeting and project/corporate strategic planning.

Finally, automating the above framework, in whole or part, would serve to increase the efficiency of controlling and managing price increases.

Providing the results or output of the above analyses in a user-friendly format would increase the likelihood that the information obtained would be taken into consideration by decision makers and thence serve as a basis for budgetary decisions and action (e.g., negotiation with vendors).

### BRIEF DESCRIPTION OF THE INVENTION

The present invention provides a system, method and computer program product for analyzing and comparing cost increases that meets the above-identified needs.

According to a first aspect of the present invention, a system for analyzing and comparing changes in costs between a first and a second time period includes a reception unit arranged to receive cost data for the first time period and cost data for the second time period, a calculation unit arranged to calculate data representing a change in cost from the first time period to the second time period, based on a difference between the cost data for the second time period and the cost data for the first time period, and an output unit arranged to output the data representing the change in cost from the first time period to the second time period. The cost data for a given time period represents a cost of a commodity purchased or to be purchased during the given time period.

According to a second aspect of the present invention, the system according to the first aspect further includes a comparison unit arranged to compare the cost data for the first time period and/or the cost data for the second time period with comparative data. The cost data for the first time period and cost data for the second time period represent prices charged by a given vendor for the commodity, and the comparative data represents a price charged by a different vendor for the commodity and/or a representative price charged by a plurality of different vendors for the commodity.

According to a third aspect of the present invention, in the system according to the first aspect the commodity includes at least two subcommodities. The cost data for each of the first and second time periods includes cost data for each subcommodity. The data representing the change in cost from the first time period to the second time period includes data representing a change in cost for each subcommodity and data representing a change in cost for the commodity. The data representing the change in cost for the commodity represents an aggregation of the data representing the change in cost for all of the subcommodities and is calculated by aggregating the data representing the change in cost for all of the subcommodities.

According to a fourth aspect of the present invention, in the system according to the second aspect the comparative data is calculated at different levels of analysis including a first level of analysis L1, at which the commodity is defined in terms of N1 variables, and one or more additional levels of analysis L2, . . . , Ln, at which the commodity is defined in terms of N2, . . . , Nn variables, respectively, where N1 is an integer equal to or greater than 0, and for each successive level L2, . . . , Ln the number of variables N2, . . . , Nn in terms of which the commodity is defined is at least one more than the number of variables in terms of which the commodity is defined at the previous level.

According to a fifth aspect of the present invention, the system according to the first aspect further includes a determination unit arranged to determine whether the cost of the commodity purchased or to be purchased during the second time period represents an increase over the cost of the commodity purchased or to be purchased during the first time period and, if the cost of the commodity purchased or to be purchased during the second time period represents an increase over the cost of the commodity purchased or to be purchased during the first time period, to determine whether the increase has been authorized, and a transmission unit arranged to transmit a warning indicating that the increase has not been authorized, if said determination unit has determined that the increase has not been authorized.

According to a sixth aspect of the present invention, in the system according to the fifth aspect the transmission unit is further arranged to transmit a message to a vendor of the commodity requesting the vendor to transmit a rate increase proposal to the buyer, if the determination unit has determined that the increase has not been authorized. The warning is transmitted to a buyer of the commodity.

According to a seventh aspect of the present invention, in the system according to the sixth aspect the rate increase proposal includes a first charge amount representing a charge by the vendor to the buyer for sale of the commodity during the second time period, based on a price charged by the vendor for the commodity during the first time period, and a second charge amount representing a charge by the vendor to the buyer for sale of the commodity during the second time period, based on a price charged by the vendor for the commodity during the second time period.

According to other aspects of the present invention, there are provided methods and computer program products corresponding to the above-described systems.

An advantage of the present invention is that it serves to notify a user (e.g., an organizational decision maker) of an increase in a cost or price, e.g., a billing rate charged by a vendor for a commodity. This puts the user in a position to control and manage price increases.

Another advantage of the present invention is that it organizes and aggregates price increase data that may be provided to the user in piecemeal fashion, as fragmentary disjointed discrete data. Aggregation can be performed at different levels of analysis, e.g., for all purchases of a commodity for a given time period, or for purchases of a commodity for a given project or matter for the given time period, etc. Accordingly, incoming price increase data is translated into a more usable form of large-scale effects of the price increases, for example, the effect on annual spending, or the effect on the budget of a given project. Thus, while price increase data may come to the decision maker's attention at different times and under a variety of disparate circumstances, and while price increase data may be provided at levels of limited usefulness in making budgetary decisions, the data may be systematized and quantified into more useful terms so as to permit more rational evaluations of it to be performed.

Another advantage of the present invention is that it can compare the price increases (or prices) charged by a given vendor for a given commodity with those charged by other individual vendors or with representative prices/price increases charged by any of various groupings of peer vendors for the given commodity. Thus, the price increase data of a given vendor may be evaluated with greater rationality in view of the market for the given commodity.

Another advantage of the present invention is that it provides consistent methodologies or modes of analysis whereby different price increases may be quantified and compared according to consistent metrics, thus permitting rational evaluation of price increases.

In addition to contributing to greater rationality in the process of making decisions pertaining to expenditures so as to facilitate budgetary management, the results output by the present invention provide the purchaser with leverage to negotiate price reductions with vendors, thus permitting the purchaser to improve cost performance without sacrificing the procurement of commodities.

Another advantage of the present invention is that it can be automated to improve its efficiency and provide results more promptly, especially for handling large amounts of data. On-line real time processing of the data aggregated at any level may be performed.

Another advantage of the present invention is that it can provide results in user-friendly, e.g., graphical and tabular, written or on-screen formats for ease of understanding, so as to increase the likelihood that the results will be put to use by the decision maker.

Thus, the present invention provides a quantitative, systematic and objective analytic framework for evaluating price increases. Based on the knowledge of the large-scale effects of price increases on the user's organization and of the comparative price (increase) data, the user can make budgetary decisions in a more rational manner, and the user is provided with greater leverage for the purpose of negotiating reductions in price increases with vendors, so as to improve cost performance of the organization. Thus, the analytic framework provided by the present invention may serve as the basis of the budgetary decision making process for use in the project planning context or in an overall scheme of organizational management.

Further features and advantages of the present invention as well as the structure and operation of various embodiments of the present invention are described in detail below with reference to the accompanying drawings.

### BRIEF DESCRIPTION OF THE DRAWINGS

The features and advantages of the present invention will become more apparent from the detailed description set forth below when taken in conjunction with the drawings.

FIG. 1 is a flow chart illustrating a process to be carried out by a purchasing entity for approval/rejection of a rate increase proposed by a vendor.

FIG. 2 shows a Rate Increase Proposal Form, containing data for an individual law firm, including data identifying the law firm and its characteristics, data representing past, current and proposed future billing rates and billing rate increases, and data representing aggregated quantities of the billing rate and billing rate increase data.

FIG. 3 shows comparative data including average billing rates for client law firms and national law firms, grouped according to various groupings.

FIG. 4 shows billing rate data for an individual law firm in comparison with billing rate data for other law firms.

FIG. 5 is a block diagram of an exemplary computer system useful for implementing the present invention.

### DETAILED DESCRIPTION OF THE INVENTION

The present invention is directed to a system, method and computer program product for analyzing and comparing increases in the cost or price of goods and/or services being purchased. The present invention is now described in more detail herein in terms of the above exemplary description. This is for convenience only and is not intended to limit the application of the present invention. In fact, after reading the following description, it will be apparent to one skilled in the relevant arts how to implement the following invention in alternative embodiments.

The features and advantages of the present invention will become more apparent from the detailed description set forth below when taken in conjunction with the figures.

Although the invention may be applied to analyze and compare cost or price increases for any commodity (any good or service), one intended application of the invention is for analyzing and comparing billing rate increases charged by law firms.

The invention is intended to be of particular utility to an institutional or organizational entity, e.g., a large corporation, in which it may be difficult to control and manage cost increases because of the large size of the entity and the difficulties of gathering all of the relevant data and analyzing that data in order to determine the actual quantitative effects of cost increases and to acquire data that can be used as leverage in negotiating with vendors to reduce proposed price increases. For ease of discussion, the term “client” may be used herein to refer to such an organizational entity.

In what follows, an example of the invention as applied to law firm billing rate increases charged to a client will be explained with reference to the figures.

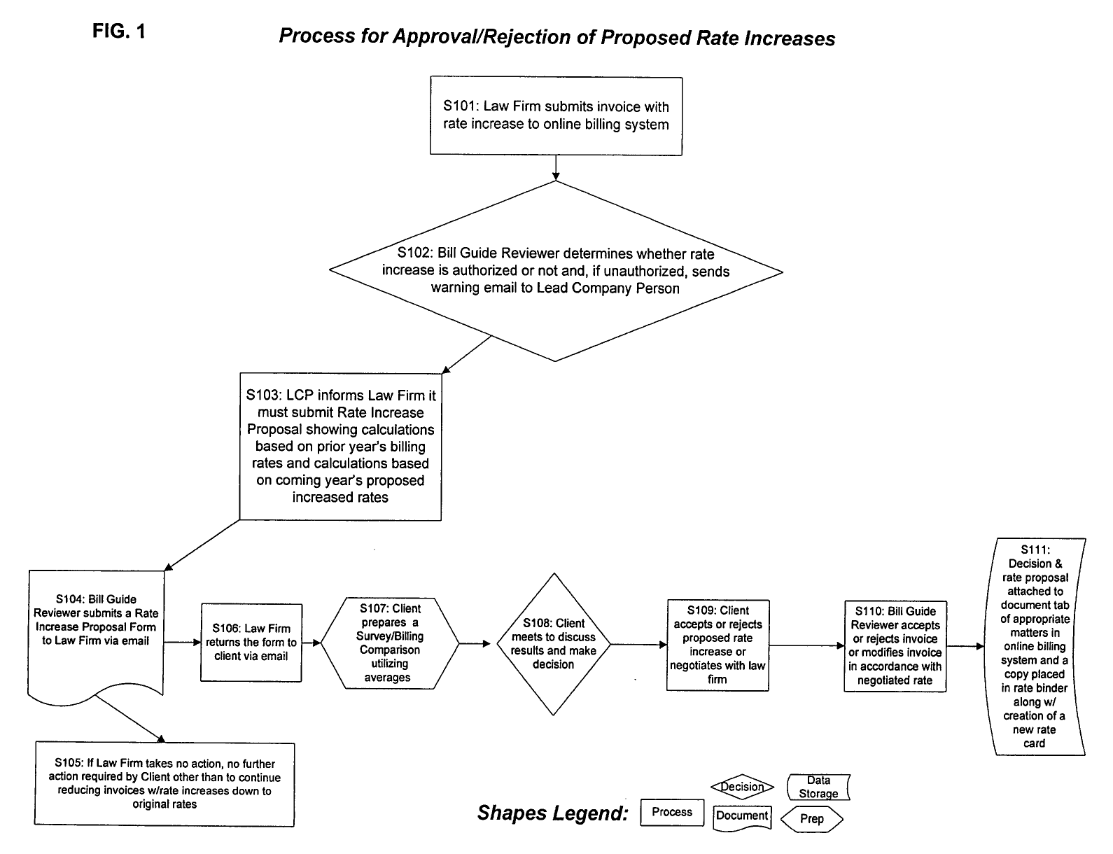

The analysis and comparison of billing rate increases is intended, though not required, to be embedded in a process for approval/rejection of proposed rate increases such as that shown in FIG. 1. The flowchart shown in FIG. 1 is understood to be self-explanatory to those of ordinary skill in the art, and hence will be elaborated on only to the extent necessary to explain the invention. The process shown in FIG. 1 would generally be controlled or overseen by a managerial level decision maker, which may be an individual or a group of individuals. Despite the decision maker's ultimate control, if the decision maker provides certain input or guidance at the outset, the process may be administered, at least in part, at a submanagerial level and may be, at least in part, automated, as will be discussed below.

As shown in FIG. 1, after a vendor law firm submits to the client an invoice reflecting a rate increase (step S101) and the client's Bill Guide Reviewer (BGR) determines that the rate increase is unauthorized (step S102), the client's Lead Company Person (LCP) informs the law firm that it must submit a Rate Increase Proposal showing calculations based on the prior year's billing rates and calculations based on the coming year's proposed increased rates (step S103), and the BGR submits a Rate Increase Proposal Form to the law firm for that purpose (step S104). (Although certain steps of the process shown in FIG. 1 indicate specific modes of communication, e.g., by email, or by submission to an online billing system, the present invention is not limited to such modes of communication but may be performed using any suitable or desired modes of communication.)

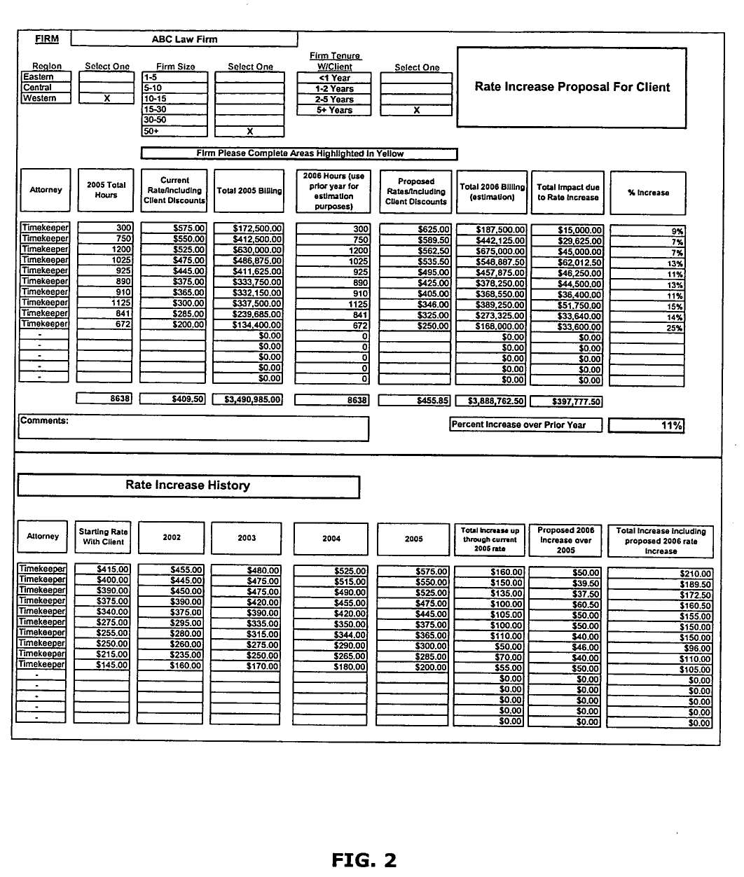

An example of the Rate Increase Proposal Form is shown in FIG. 2. This Rate Increase Proposal Form (to be explained in more detail below) provides an example of the data to be input into the system. The Rate Increase Proposal Form contains data for a single vendor law firm. (In FIG. 2, the form contains data for ABC Law Firm.) It is understood that the client may purchase legal services from a number of different law firms. Using the process shown in FIG. 1, the client will submit a Rate Increase Proposal Form to each of its vendor law firms that submits an invoice reflecting an unauthorized billing rate increase.

Upon initial implementation of the system, the client may also request whatever information on the Rate Increase Proposal Form is appropriate (discussed below) from each of its vendor law firms that is not submitting an unauthorized rate increase, in order to acquire pertinent data for performing comparative analyses (discussed below).

The determination as to whether a billing rate increase has been authorized or not by the client (step S102) may be made, e.g., by a human manager or by a computer, based on the client's records. If desired, the client may employ a rule according to which any billing rate increase submitted by any vendor law firm is determined to be unauthorized by default, unless the client's record/file for the vendor law firm in question has been expressly annotated to the effect that the billing rate increase in question has been authorized by the client.

At the top of the Rate Increase Proposal Form (FIG. 2) the name of the particular law firm (here, “ABC Law Firm”) whose data is displayed thereon is listed. Underneath the firm name, values are entered for various parameters defining, for the client's purposes, what type of law firm ABC Law Firm is. These parameters may include, for example, geographical region, city (not shown), firm size, firm tenure with client, type of legal services provided (e.g., patent, real estate, tax, etc.) (not shown), and/or others (not shown). Parameters not shown in the figures will not be discussed, but could easily be accommodated by the system in the same manner as the illustrated parameters, as will be understood by one of ordinary skill in the art.

In the area of the form below the firm identification section, the vendor law firm (ABC Law Firm) is to enter values for each of its employees (timekeepers) who performs work for the client, including the total number of hours billed to the client by that timekeeper last year (“2005 Total Hours”), the billing rate for that timekeeper for last year (“Current Rate”), and the proposed increased billing rate for that timekeeper for the coming year (“Proposed Rate”). In the illustrated example, the first-listed timekeeper is shown as having 300 hours for 2005, a current billing rate of $575.00, and a proposed increased billing rate of $625.00.

From these values entered by the vendor law firm for each timekeeper, the system calculates the total amount billed for each timekeeper last year (“Total 2005 Billing”) (=total number of hours*current billing rate) ($172,500.00 for the first-listed timekeeper in FIG. 2) and the total amount expected to be billed for each timekeeper for the coming year (“Total 2006 Billing”) (=total number of hours*proposed billing rate) ($187,500.00 for the first-listed timekeeper in FIG. 2). In order to calculate the total amount expected to be billed for a given timekeeper for the coming year, the system uses the total number of hours billed to the client by that timekeeper last year as an estimate of the total number of hours expected to be billed by that timekeeper for the coming year (“2006 Hours”).

The system further calculates the estimated total quantitative effect (on the client in the coming year) of each timekeeper's proposed rate increase (“Total Impact due to Rate Increase”), which is equal to the difference between the total amount expected to be billed by that timekeeper for the coming year and the total amount billed by that timekeeper last year (“Total 2006 Billing”−“Total 2005 Billing”) ($15,000.00 for the first-listed timekeeper in FIG. 2). This total quantitative effect is also calculated in percentage terms (“% Increase”) (9% for the first-listed timekeeper in FIG. 2).

Based on the above entered and calculated values, the system also calculates totals and averages for all the timekeepers of the law firm who perform work for the client. Specifically, the system calculates total hours, total billing amounts, and average billing rates, both for the last year and for the coming year, totaled or averaged (as the case may be) over all of the timekeepers of the law firm who perform work for the client. In FIG. 2, these values are shown at the bottom of the top half of the page (total hours for 2005=8638; average current billing rate=$409.50; total 2005 billing=$3,490,985.00; total hours for 2006=8638; average proposed increased billing rate=$455.85; estimated total 2006 billing=$3,888,762.50). The system further calculates the total quantitative effect of the proposed rate increases that is expected to be felt by the client in the coming year, which is equal to the difference between the total amount expected to be billed (by all the timekeepers of the law firm who perform work for the client) for the coming year and the total amount billed (by all the timekeepers of the law firm who perform work for the client) last year (“Total 2006 Billing”−“Total 2005 Billing”). In the example illustrated in FIG. 2, the total quantitative effect (“Total Impact due to Rate Increase”) (covering all the timekeepers working for the client) is given as $397,777.50. This total quantitative effect is also calculated in percentage terms (“% Increase”), which in the illustrated example amounts to an increase of 11% over the cost of the law services for the previous year. It may be noted that since the since the system uses the last year's total number of hours billed to the client as an estimate of the next year's total number of hours expected to be billed to the client, the system effectively indicates what the legal services to be purchased by the client during the next year would cost at the proposed new rate (“Total 2006 Billing”) and what they would cost at the old rate (“Total 2005 Billing”).

The Rate Increase Proposal Form also includes a “Rate Increase History” section, illustrated in the bottom portion of FIG. 2. The vendor law firm is also to enter the historical billing rates for each timekeeper who performs work for the client, from the initial billing rate charged to the client up through the current billing rate and the proposed increased billing rate. From these entered values the system calculates, for each timekeeper, the total increase in the billing rate up through the current (2005) rate, the total increase in the billing rate up through the proposed (2006) increased rate, and the increase from the current rate to the proposed increased rate. For example, as shown in FIG. 2, the first-listed timekeeper had (has) an initial billing rate of $415.00, a 2002 billing rate of $455.00, a 2003 billing rate of $480.00, a 2004 billing rate of $525.00 and a 2005 billing rate of $575.00. For this timekeeper, the total increase in the billing rate up through the current (2005) rate is $160.00, the total increase in the billing rate up through the proposed (2006) increased rate is $210.00, and the increase from the current rate to the proposed increased rate is $50.00. Although not shown in the illustrated example, it would also be possible to calculate various averages (over all timekeepers), such as the average historical billing rates (average initial billing rate and average billing rate for each subsequent year), the average increase in the billing rate up through the current rate, the average increase in the billing rate up through the proposed increased rate, and the average increase from the current rate to the proposed increased rate.

While it is understood that the client depends on the vendor law firm as the ultimate source of the basic data (timekeeper, hours billed, billing rates), it is not critical to the invention who enters the values in the Rate Increase Proposal Form, or whether certain values (e.g., total billing amount for a given year for a given timekeeper) are calculated (derived) or simply input.

Of course, the actual data collected from each of the client's vendor law firms may be varied as appropriate. For example, the number of years of historical billing rate data collected may be varied. Again, the client may not require data for all of the timekeepers of a given vendor law firm who perform work for the client or, alternatively, the client may want data even for those timekeepers of the vendor law firm who do not perform work for the client. Other variations in the type and amount of data collected will be appreciated by those of ordinary skill in the art.

Furthermore, any additional billing rate data may be accommodated by modifying the Rate Increase Proposal Form as necessary. For example, if a given timekeeper bills out at different billing rates for different types of tasks, such data could be incorporated into the form. Instead of collecting data merely per timekeeper, data could be collected per timekeeper and per task type. Other variations subsumable under the basic concept exemplified by the illustrated Rate Increase Proposal Form will be appreciated by those of ordinary skill in the art.

In addition, of course, the data collected from the vendor law firms may be organized in alternative fashion. For example, the client may wish to aggregate the data shown on the top half of the Rate Increase Proposal Form (FIG. 2) not only in toto, as is illustrated, but also (or alternatively) for a given individual matter (e.g., litigation) or for each individual matter for which the vendor law firm provides services for the client, or again for a given or each type of legal services provided by the vendor law firm to the client, or again for a given or each project of the client for which the vendor law firm provides services for the client (the term “matter” is used to refer to a given task or assignment as defined by the vendor law firm, and the term project is used to refer to a given task or operation as defined by the client). As a further alternative, the client may wish to aggregate the data for a given or each subentity (e.g., branch or department, or subsidiary) of the client entity. Other alternative aggregations such as may prove useful or desirable will be appreciated by those of ordinary skill in the art.

Not only can the data be aggregated at various levels of analysis, but aggregations can also be performed at multiple, nested levels of analysis. For example, the data may be aggregated for each matter performed for a given project, for each matter performed for a given subentity, for each type of legal services performed for a given subentity, or the like. As an example, if three types of legal services, patent, tax, and contract, were performed for project X, the totals and averages (for all timekeepers working on patent matters for project X, for all timekeepers working on tax matters for project X, and for all timekeepers working on contract matters for project X) could be calculated. In this way, the relative costs, and the relative proposed cost increases, of patent work, tax work and contract work for project X could be obtained. These costs/cost increases could be compared, for example, with each other, with the corresponding values for the same types of work performed for other projects, and with the corresponding values for the same types of work performed for the totality of the client's projects.

Thus, by using the Rate Increase Proposal Form, the client is able to translate or convert discrete price increase data from a given vendor law firm (e.g., an increase in a billing rate per hour for a given timekeeper) into objective quantified effects at any or all appropriate or desired levels of analysis (levels of aggregation), measured according to a single metric. The data thus calculated according to the concept exemplified by the Rate Increase Proposal From, both in itself and when used for comparative analyses (discussed below), serves as the basis for more rational budgetary decision making. Using this converted data in itself, the client can more accurately and easily assess the affordability of the legal services at the new rates (e.g., in view of the client's overall budget) and the desirability of continuing to purchase the legal services (e.g., in view of the value the legal services realize for the client). On the basis of such improved assessment, the client can make more rational expenditure decisions with respect to the given legal services.

Let us now turn to the comparative analyses to which the output data of the Rate Increase Proposal Form for a given vendor law firm may be applied.

As noted, a Rate Increase Proposal Form is submitted to each of the client's vendor law firms that submits an unauthorized billing rate increase but may also be submitted to each of the client's vendor law firms that does not submit an unauthorized billing rate increase. The reason for submitting such form to the firms that do not submit an unauthorized billing rate increase is to obtain the corresponding data from those firms in order to perform comparative analyses comparing a given individual law firm vendor (e.g., one submitting an unauthorized billing rate increase) with other or all of the client's vendor law firms.

Returning to FIG. 1, if the vendor law firm that submitted an invoice reflecting an unauthorized billing rate increase fails to return the Rate Increase Proposal Form to the client, the client may simply reduce the law firm's invoices down to the previous rates (step S105).

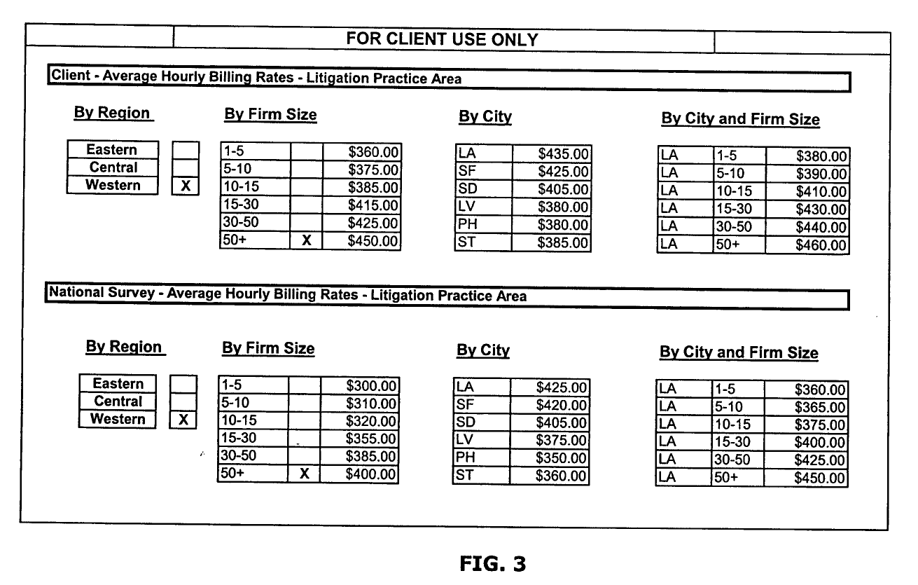

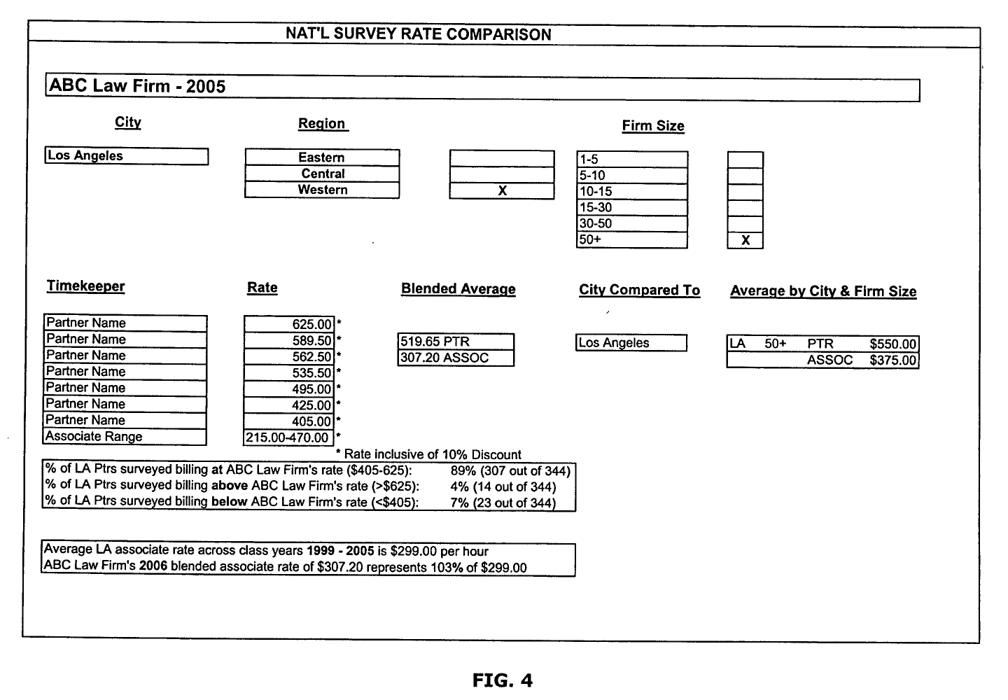

If the law firm returns the Rate Increase Proposal Form to the client (step S106), the client analyzes the proposed rate increase by considering the aggregate effects on the client both in themselves (as discussed above) and in comparative context. Thus, the client performs comparative analyses comparing the given vendor law firm's proposed billing rate increase with other vendor law firms from which the client purchases legal services and with other law firms generally (step S107). A variety of comparative analyses may be performed, as will be described with reference to FIGS. 3 and 4.

Before describing the comparative analyses involving comparative data from other law firms, it is to be noted that, as described above, what may be referred to as internal comparisons may also be performed, e.g., comparing different legal services provided by a given vendor law firm. For example, the costs of legal services for different matters (e.g., different litigations) may be compared with each other, in light of the relative values (measured by some appropriate metric) of the different matters to the client. If the costs of legal services for a given matter were disproportionately high relative to the value the legal services realize for the client, the client could take appropriate action, e.g., attempt to negotiate a fee reduction with the vendor law firm, discontinue the matter, etc. Similar comparisons could be made between, e.g., the costs of different types of legal services (e.g., patent, tax, contract), the costs of legal services for different projects, and the costs of legal services for different subentities of the client entity, in light of the relative value provided to the client by the respective services.

Turning now to what may be referred to as external comparisons, i.e., comparisons between a given vendor law firm and other law firms, FIG. 3 illustrates some basic comparative data that the system may provide. The upper portion of the figure (“Client−Average Hourly Billing Rates−Litigation Practice Area”) shows comparative data for other vendor law firms that perform work for the client (“client law firms”), while the lower portion of the figure (“National Survey−Average Hourly Billing Rates−Litigation Practice Area”) shows comparative data for U.S. law firms generally. The comparative data for the client law firms may represent all such law firms or, e.g., a representative sample of such law firms. Alternatively, the comparative data for the client law firms could represent client law firms of a particular type (e.g., patent law firms) or, e.g., a representative sample of such law firms. Similarly, the comparative data for U.S. law firms generally may represent all U.S. law firms or, e.g., a representative sample of U.S. law firms. Alternatively, the comparative data for the U.S. law firms could represent U.S. law firms of a particular type (e.g., patent law firms) or, e.g., a representative sample of such law firms.

In the illustrated example, the comparative data consists of average billing rates for different subgroupings of firms within the group of client law firms or the group of U.S. law firms. By “average” is meant the arithmetic mean. It would be possible to provide other comparative data (e.g., median billing rates or other representative billing rates) as an alternative or supplement. As an example of the provision of such other comparative data, the percentages and/or numbers of timekeepers (of the group of firms in question) billing within each of certain discrete billing rate ranges could be provided, the ranges encompassing the entire spectrum of billing rates (of the group of firms in question) from lowest to highest.

In the illustrated example, the given vendor law firm for which comparative data is provided, ABC Law Firm, is a law firm located in the western region of the United States. Accordingly, it is compared with other firms (both client firms and firms generally) located in the western region, as indicated by the fact that, under the heading “By Region” in FIG. 3 the box for “Western” is ticked. Under the heading “By Firm Size” the average billing rates are given for other law firms (within the client group, shown on the top, or within the national group, shown on the bottom) of the indicated size in the western region. For example, the average billing rate for law firms in the western region having a size of 50 or more attorneys is $400.00, the average billing rate for client law firms in the western region having a size of 50 or more attorneys is $450.00, and so on. Under the heading “By City” the average billing rates are given for other law firms (within the client group, shown on the top, or within the national group, shown on the bottom) located in the indicated city in the western region. For example, the average billing rate for law firms located in Los Angeles is $425.00, the average billing rate for client law firms located in Los Angeles is $435.00, and so on. (The abbreviations LA, SF, SD, LV, PH and ST stand for Los Angeles, San Francisco, San Diego, Las Vegas, Phoenix and Seattle, respectively.) Under the heading “By City and Firm Size” the average billing rates are given for other law firms (within the client group, shown on the top, or within the national group, shown on the bottom) of the indicated size located in the indicated city. For example, the average billing rate for law firms located in Los Angeles having a size of 50 or more attorneys is $450.00, the average billing rate for client law firms located in Los Angeles having a size of 50 or more attorneys is $460.00, and so on. For the sake of convenience, data for only a single city (LA) at each of the different firm sizes is illustrated in the “City+Firm Size” data, but the system may of course provide such data for any or all of the cities covered.

Of course, the subgroupings as to region, firm size, city, and so on are not to be taken as being limited to the example illustrated in FIG. 3. It would be possible, for example, to divide the U.S. into different regions, to divide firms into different size categories (e.g., 1-10, 10-50, 50-100, 100+), to use different cities, etc. It would also be possible to include comparative data representing different subgroupings altogether, e.g., to include a section “By Type of Legal Services,” in which average billing rates could be provided for different types of law firms, e.g., patent law firms. Alternatively, average billing rates could be provided not by law firm but simply by type of legal services, e.g., average billing rates for patent legal services, for tax legal services, etc. It would also be possible to provide nested or combined data of different types than that illustrated. For example, in addition to comparative data by the groupings of city+firm size, comparative data by the groupings of region+firm size, city+type of legal services, firm size+city+type of legal services, or any other desired combination could be provided. It would also be possible to include data representing overall groupings other than client firms and U.S. firms. For example, world law firms or law firms in a particular foreign country could be used as an overall grouping. Other variations will be appreciated by those of ordinary skill in the art.

Furthermore, the order in which comparisons are carried out (i.e., the order in which levels of comparative analysis are nested) and, correspondingly, the presentation format of the results, may be varied as desired. For example, ABC Law Firm could have been initially categorized based on its size rather than its region, and then compared with other firms of its size located in the various regions, and so on. According to this example, FIG. 3 would be revised to show “By Firm Size” at the leftmost position instead of “By Region,” and “By Region,” at the second-to-leftmost position instead of “By Firm Size” the box for 50+ would be ticked under the heading “By Firm Size,” and the average billing rate for firms of size 50+ in each of the eastern, central and western regions would be given under the heading “By Region,” and so on. Any such variation in the order of nesting of different levels of analysis is possible. (Of course, it is not required to provide data reflecting nested levels of analysis, nor is it required to include data for any particular subgrouping (region, firm size, city, etc.) shown or discussed herein.)

The billing rates for the individual vendor law firm, ABC Law Firm, in particular the average billing rates (e.g., the current billing rate of $409.50 and the proposed increased billing rate of $455.85), may be usefully compared with the appropriate averages shown in FIG. 3. Most significant will be comparisons between ABC Law Firm and similarly situated firms. Since ABC Law Firm is a firm of size 50+ attorneys, located in the western region and in particular in Los Angeles (see FIG. 4), the most pertinent comparison will be with the average billing rate for western region firms having a size of 50+ attorneys ($400.00 for law firms generally, and $450.00 for client law firms), law firms in Los Angeles ($425.00 for law firms generally, and $435.00 for client law firms), and law firms in Los Angeles having a size of 50+ attorneys ($450.00 for law firms generally, and $460.00 for client law firms).

While FIG. 2 illustrates billing rate data for an individual vendor law firm and FIG. 3 illustrates comparative billing rate data for other law firms (both client law firms and law firms in general), FIG. 4 illustrates billing rate data for an individual vendor law firm in comparison with billing rate data for other law firms. The upper portion of FIG. 4 gives the name of the individual law firm (here, ABC Law Firm) as well as values for various parameters defining what type of law firm ABC Law Firm is, in fashion similar to FIG. 2. Underneath the firm parameters section, the individual timekeepers (“Timekeeper”) of ABC Law Firm and their billing rates (“Rate”) are listed, together with the average billing rate for partners and the average billing rate for associates (“Blended Average”) of ABC Law Firm. At the right side, the corresponding average billing rates for partners and associates for firms located in the same city as ABC Law Firm (here, Los Angeles) are provided. Underneath this section, there are provided the percentages (and absolute numbers) of partners in law firms in the same city whose billing rates are the same as (i.e., in the same range as) those of the partners of ABC Law Firm (here, 89% or 307), whose billing rates are above ABC Law Firm's (highest) partner rate (here, 4% or 14), and whose billing rates are below ABC Law Firm's (lowest) partner rate (here, 7% or 23). Underneath this section, there are provided the average billing rate for associates in firms located in the same city as ABC Law Firm (here, $299.00), and the average billing rate for associates at ABC Law Firm, in both absolute dollar terms (here, $307.20) and in terms of a percentage of the average billing rate for associates in firms located in the same city as ABC Law Firm (here, 103%).

Of course, many variations on the data shown in FIG. 4 are possible within the scope of the invention. The illustrated comparative data, i.e., the average billing rates for partners and associates for firms located in the same city as ABC Law Firm may be averages representing either client law firms or law firms generally, as described above with reference to FIG. 3. Moreover, the comparative data could be exchanged with, or supplemented by, other comparative data, such as the various types of comparative data illustrated in and discussed above with reference to FIG. 3, e.g., average billing rates according to other law firm groupings, subgroupings or combinations thereof. If desired, the overall average billing rate of both partners and associates at ABC Law Firm (shown in FIG. 2) could be illustrated in FIG. 4 (e.g., together with the corresponding overall average billing rate for law firms in the same city, or for law firms of some other grouping, and the percentages and absolute numbers of attorneys at law firms in the same city or other grouping, at, above and below the overall average billing rate of ABC Law Firm.).

Thus, FIG. 4 offers an example not only of comparative data beyond that of FIG. 3, but also of a format for displaying the results (output) of data collection, analysis and comparison performed by the system of the present invention. In other words, FIG. 4 offers an example of presenting billing rate data for an individual law firm (whose billing rates are under analysis) in comparison with pertinent data of other law firms situated, e.g., in similar or related circumstances. Of course, any number of variations on this format are possible within the scope of the invention, as will be understood by those of ordinary skill in the art.

The comparative data of either FIG. 3 or FIG. 4, or both, could of course be extended to include comparative historical data corresponding to or pertinent to the historical data for the individual law firm under comparison shown in FIG. 2.

It will be appreciated by one of ordinary skill in the art that the kinds of data (both individual law firm data and comparative data) collected, the kinds of analyses and comparisons performed, and the kinds of output displayed by the system of the invention may be varied due to, e.g., changes in market factors over time, circumstances particular to an individual client, or to other reasons, and that the basic concepts of the analytic and comparative framework of the invention have a general applicability independent of particular data and of particular ways of organizing, aggregating and displaying it, which are exemplified herein. Examples of some such variations may be found in U.S. patent application Ser. No. 11/290,562 and U.S. Provisional Patent Application No. 60/712,428, which are hereby incorporated herein by reference in their entirety.

Regarding the input of the data required by the system, both the individual and the comparative data may be input automatically and/or electronically by means understood by those of ordinary skill in the art. For example, data from the client's vendors may be automatically electronically transferred to a storage medium for ultimate use by the system of the invention, upon submission of each invoice from each vendor. The transferred data may be modified and enriched as necessary for use by the system. By such means the system may obtain not only the data for the individual vendor whose unauthorized billing rate increase is to be analyzed but also the comparative data for all of the client's vendors, which is to be used in comparing the individual vendor presenting an unauthorized billing rate increase with the client's vendors generally.

As for the results or output of the system of the invention, once the client is armed with the data representing the quantified effects, at appropriate large-scale levels of analysis, of the proposed billing rate increase (of the law firm whose unauthorized rate increase is under consideration) and with the comparative data, both internal and external, the client's decision maker is in a position to objectively and rationally evaluate the extent to which the client can afford to pay the proposed increased rates, the desirability of continuing to purchase the legal services in question in light of the value they realize for the client, and the reasonableness of the proposed rate increase in view of the market and pertinent competitor rates. Based on such evaluation, the client makes a decision to accept or reject the proposed rate increase or, alternatively, to negotiate with the law firm in an attempt to persuade the law firm to reduce the amount of the proposed increase (FIG. 1, step S108). For example, in the case of the example of ABC Law Firm illustrated in FIGS. 2-4, the proposed billing rate increase may appear reasonable from the standpoint of a comparison with other law firms (of the client or generally). That is, although the average ($455.85; FIG. 2) of the proposed new (2006) billing rates (shown in FIGS. 2 and 4) of ABC Law Firm is higher than the average billing rate of law firms in general of the same size (50+) in the same region (western) ($400.00; FIG. 3), it is in line with the average billing rate of client law firms of the same size in the same region ($450.00; FIG. 3), with the average billing rate of law firms generally of the same size in the same city (LA) ($450.00; FIG. 3) and with the average billing rate of client law firms of the same size and in the same city ($460.00; FIG. 3). Again, as shown by the data given in FIG. 4, at ABC Law Firm's proposed new billing rates, the range of partner billing rates of ABC Law Firm is in line with the average for partners in the same city (89% bill in the same range), and the average associate billing rate of ABC Law Firm is in line with the average for associates in the same city (ABC associate average billing rate is 103% of city average). (Of course, the decision whether to accept or reject a proposed rate increase, or to pursue negotiations, would be made by also taking into account factors internal to the client, which are not presented here (client's budget or ability to afford the legal services; relative degree of importance of the legal services to the client, as measured by the value they generate for the client, compared to other legal services provided by the same and other law firms).) In the case of this example, if the internal factors that go into the client's decision suggested that it were reasonable to accept the proposed rate increase, it may be expected that the client would decide to accept the proposed rate increase in view of the external factors.

After the client makes its decision to accept or reject the proposed rate increase or commence negotiations with the vendor law firm, the client communicates the same to the vendor law firm (FIG. 1, step S109). Subsequently, the client's Bill Guide Reviewer (BGR) accepts, rejects or modifies the law firm's invoice accordingly (step S110). A modification of the invoice would reflect the outcome of a negotiated agreement between vendor and client, whereby the unauthorized rate increase was (e.g., partly) reduced. The client's decision (or the outcome of negotiation) and any increase in the vendor law firm's billing rates accepted by the client are documented in the appropriate records of the client (step S111).

Returning to steps S108 and S109, once the client is armed with the data as described above, the client is in a better position to negotiate a reduction in the proposed rate increase with the vendor law firm, because the client can present to the vendor law firm objective, quantitative evidence of the extent to which the client can afford the proposed rate increase and of the extent to which the proposed rate increase is reasonable (e.g., in view of the value generated by the legal services in question, the history of the vendor law firm's billing rates for the legal services in question, the vendor law firm's billing rates for other legal services provided to the client, and/or pertinent billing rates of other comparable law firms). Accordingly, a negotiated compromise, i.e., a modification of the proposed rate increase, may be reached between the client and the vendor law firm. For example, if the external factors (the output of the comparative analyses) had indicated that the proposed new billing rate was significantly higher than the average of the market (e.g., competitor firms of the same size in the same city), the client may well have turned to negotiations with the vendor law firm. By presenting the vendor law firm with objective market data, the client may be able to exert more pressure on the vendor law firm to reduce its billing rates. Of course, data pertaining to the client's ability to afford the proposed increased rates and to the relative value generated by the legal services in question may also prove to be successful leverage for the client in negotiating with the vendor.

Example Implementations

The present invention, or any part(s) or function(s) thereof, may be implemented using hardware, software or a combination thereof and may be implemented in one or more computer systems or other processing systems. However, the manipulations performed by the present invention were often referred to in terms, such as adding or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

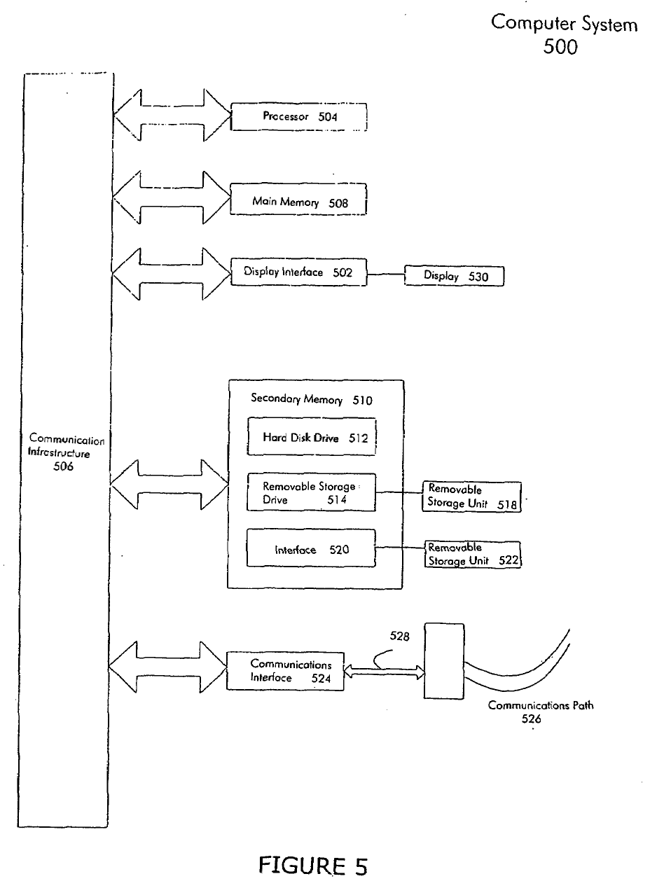

In fact, in one embodiment, the invention is directed toward one or more computer systems capable of carrying out the functionality described herein. An example of a computer system 500 is shown in FIG. 5.

The computer system 500 includes one or more processors, such as processor 504. The processor 504 is connected to a communication infrastructure 506 (e.g., a communications bus, cross-over bar, or network). Various software embodiments are described in terms of this exemplary computer system. After reading this description, it will become apparent to a person skilled in the relevant arts how to implement the invention using other computer systems and/or architectures.

Computer system 500 can include a display interface 502 that forwards graphics, text, and other data from the communication infrastructure 506 (or from a frame buffer not shown) for display on the display unit 530.

Computer system 500 also includes a main memory 508, preferably random access memory (RAM), and may also include a secondary memory 510. The secondary memory 510 may include, for example, a hard disk drive 512 and/or a removable storage drive 514, representing a floppy disk drive, a magnetic tape drive, an optical disk drive, etc. The removable storage drive 514 reads from and/or writes to a removable storage unit 518 in a well known manner. Removable storage unit 518 represents a floppy disk, magnetic tape, optical disk, etc. which is read by and written to by removable storage drive 514. As will be appreciated, the removable storage unit 518 includes a computer usable storage medium having stored therein computer software and/or data.

In alternative embodiments, secondary memory 510 may include other similar devices for allowing computer programs or other instructions to be loaded into computer system 500. Such devices may include, for example, a removable storage unit 522 and an interface 520. Examples of such may include a program cartridge and cartridge interface (such as that found in video game devices), a removable memory chip (such as an erasable programmable read only memory (EPROM), or programmable read only memory (PROM)) and associated socket, and other removable storage units 522 and interfaces 520, which allow software and data to be transferred from the removable storage unit 522 to computer system 500.

Computer system 500 may also include a communications interface 524. Communications interface 524 allows software and data to be transferred between computer system 500 and external devices. Examples of communications interface 524 may include a modem, a network interface (such as an Ethernet card), a communications port, a Personal Computer Memory Card International Association (PCMCIA) slot and card, etc. Software and data transferred via communications interface 524 are in the form of signals 528 which may be electronic, electromagnetic, optical or other signals capable of being received by communications interface 524. These signals 528 are provided to communications interface 524 via a communications path (e.g., channel) 526. This channel 526 carries signals 528 and may be implemented using wire or cable, fiber optics, a telephone line, a cellular link, a radio frequency (RF) link and other communications channels.

In this document, the terms “computer program medium” and “computer usable medium” are used to generally refer to media such as removable storage drive 514, a hard disk installed in hard disk drive 512, and signals 528. These computer program products provide software to computer system 500. The invention is directed to such computer program products.

Computer programs (also referred to as computer control logic) are stored in main memory 508 and/or secondary memory 510. Computer programs may also be received via communications interface 524. Such computer programs, when executed, enable the computer system 500 to perform the features of the present invention, as discussed herein. In particular, the computer programs, when executed, enable the processor 504 to perform the features of the present invention. Accordingly, such computer programs represent controllers of the computer system 500.

In an embodiment where the invention is implemented using software, the software may be stored in a computer program product and loaded into computer system 500 using removable storage drive 514, hard drive 512 or communications interface 524. The control logic (software), when executed by the processor 504, causes the processor 504 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant arts.

In yet another embodiment, the invention is implemented using a combination of both hardware and software.

Conclusion

While various embodiments of the present invention have been described above, it should be understood that they have been presented by way of example, and not limitation. It will be apparent to persons skilled in the relevant arts that various changes in form and detail can be made therein without departing from the spirit and scope of the present invention. Thus, the present invention should not be limited by any of the above-described exemplary embodiments, but should be defined only in accordance with the following claims and their equivalents.

In addition, it should be understood that the figures appended hereto, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the steps and processes recited in the claims need not be performed in the order presented.

What is claimed is:

1. A method of analyzing and comparing changes in costs between a first and a second time period, comprising:
a first step of receiving cost data for the first time period and cost data for the second time period;
a second step of calculating data representing a change in cost from the first time period to the second time period, based on a difference between the cost data for the second time period and the cost data for the first time period; and
a third step of outputting the data representing the change in cost from the first time period to the second time period,
wherein the cost data for a given time period represents a cost of a commodity purchased or to be purchased during the given time period.

2. A method according to claim 1, further comprising:
a fourth step of comparing the cost data for the first time period and/or the cost data for the second time period with comparative data,
wherein the cost data for the first time period and the cost data for the second time period represent prices charged by a given vendor for the commodity, and the comparative data represents a price charged by a different vendor for the commodity and/or a representative price charged by a plurality of different vendors for the commodity.

3. A method according to claim 1, wherein
the commodity includes at least two subcommodities,
the cost data for each of the first and second time periods includes cost data for each subcommodity,
the data representing the change in cost from the first time period to the second time period includes data representing a change in cost for each subcommodity and data representing a change in cost for the commodity, and
the data representing the change in cost for the commodity represents an aggregation of the data representing the change in cost for all of the subcommodities and is calculated by aggregating the data representing the change in cost for all of the subcommodities.

4. A method according to claim 2, wherein the comparative data is calculated at different levels of analysis including a first level of analysis L1, at which the commodity is defined in terms of N1 variables, and one or more additional levels of analysis L2, . . . , Ln, at which the commodity is defined in terms of N2, . . . , Nn variables, respectively, where N1 is an integer equal to or greater than 0, and for each successive level L2, . . . , Ln the number of variables N2, . . . , Nn in terms of which the commodity is defined is at least one more than the number of variables in terms of which the commodity is defined at the previous level.

5. A method according to claim 1, further comprising:
a fourth step of determining whether the cost of the commodity purchased or to be purchased during the second time period represents an increase over the cost of the commodity purchased or to be purchased during the first time period and, if the cost of the commodity purchased or to be purchased during the second time period represents an increase over the cost of the commodity purchased or to be purchased during the first time period, determining whether the increase has been authorized; and
a fifth step of transmitting a warning indicating that the increase has not been authorized if, in said fourth step, the increase has been determined not to be authorized.

6. A method according to claim 5,
wherein said fifth step further comprises transmitting a message to a vendor of the commodity requesting the vendor to transmit a rate increase proposal to a buyer of the commodity if, in said fourth step, the increase has been determined not to be authorized, and
wherein the warning is transmitted to the buyer of the commodity.

7. A method according to claim 6, wherein the rate increase proposal includes a first charge amount representing a charge by the vendor to the buyer for sale of the commodity during the second time period, based on a price charged by the vendor for the commodity during the first time period, and a second charge amount representing a charge by the vendor to the buyer for sale of the commodity during the second time period, based on a price charged by the vendor for the commodity during the second time period.

8. A system for analyzing and comparing changes in costs between a first and a second time period, comprising:
a reception unit arranged to receive cost data for the first time period and cost data for the second time period;
a calculation unit arranged to calculate data representing a change in cost from the first time period to the second time period, based on a difference between the cost data for the second time period and the cost data for the first time period; and
an output unit arranged to output the data representing the change in cost from the first time period to the second time period,
wherein the cost data for a given time period represents a cost of a commodity purchased or to be purchased during the given time period.

9. A system according to claim 8, further comprising:
a comparison unit arranged to compare the cost data for the first time period and/or the cost data for the second time period with comparative data,
wherein the cost data for the first time period and the cost data for the second time period represent prices charged by a given vendor for the commodity, and the comparative data represents a price charged by a different vendor for the commodity and/or a representative price charged by a plurality of different vendors for the commodity.

10. A system according to claim 8, wherein
the commodity includes at least two subcommodities,
the cost data for each of the first and second time periods includes cost data for each subcommodity,
the data representing the change in cost from the first time period to the second time period includes data representing a change in cost for each subcommodity and data representing a change in cost for the commodity, and
the data representing the change in cost for the commodity represents an aggregation of the data representing the change in cost for all of the subcommodities and is calculated by aggregating the data representing the change in cost for all of the subcommodities.

11. A system according to claim 9, wherein the comparative data is calculated at different levels of analysis including a first level of analysis L1, at which the commodity is defined in terms of N1 variables, and one or more additional levels of analysis L2, . . . , Ln, at which the commodity is defined in terms of N2, . . . , Nn variables, respectively, where N1 is an integer equal to or greater than 0, and for each successive level L2, . . . , Ln the number of variables N2, . . . , Nn in terms of which the commodity is defined is at least one more than the number of variables in terms of which the commodity is defined at the previous level.

12. A system according to claim 8, further comprising:
a determination unit arranged to determine whether the cost of the commodity purchased or to be purchased during the second time period represents an increase over the cost of the commodity purchased or to be purchased during the first time period and, if the cost of the commodity purchased or to be purchased during the second time period represents an increase over the cost of the commodity purchased or to be purchased during the first time period, to determine whether the increase has been authorized; and
a transmission unit arranged to transmit a warning indicating that the increase has not been authorized, if said determination unit has determined that the increase has not been authorized.

13. A system according to claim 12,
wherein said transmission unit is further arranged to transmit a message to a vendor of the commodity requesting the vendor to transmit a rate increase proposal to a buyer of the commodity, if said determination unit has determined that the increase has not been authorized, and
wherein the warning is transmitted to the buyer of the commodity.

14. A system according to claim 13, wherein the rate increase proposal includes a first charge amount representing a charge by the vendor to the buyer for sale of the commodity during the second time period, based on a price charged by the vendor for the commodity during the first time period, and a second charge amount representing a charge by the vendor to the buyer for sale of the commodity during the second time period, based on a price charged by the vendor for the commodity during the second time period.

15. A computer program product comprising a computer-usable medium having control logic stored therein for causing a computer to analyze and compare changes in costs between a first and a second time period, the control logic comprising:
first computer-readable program code for causing the computer to receive cost data for the first time period and cost data for the second time period;
second computer-readable program code for causing the computer to calculate data representing a change in cost from the first time period to the second time period, based on a difference between the cost data for the second time period and the cost data for the first time period; and
third computer-readable program code for causing the computer to output the data representing the change in cost from the first time period to the second time period,
wherein the cost data for a given time period represents a cost of a commodity purchased or to be purchased during the given time period.

16. A computer program product according to claim 15, further comprising:
fourth computer-readable program code for causing the computer to compare the cost data for the first time period and/or the cost data for the second time period with comparative data,
wherein the cost data for the first time period and the cost data for the second time period represent prices charged by a given vendor for the commodity, and the comparative data represents a price charged by a different vendor for the commodity and/or a representative price charged by a plurality of different vendors for the commodity.

17. A computer program product according to claim 15, wherein
the commodity includes at least two subcommodities,
the cost data for each of the first and second time periods includes cost data for each subcommodity,
the data representing the change in cost from the first time period to the second time period includes data representing a change in cost for each subcommodity and data representing a change in cost for the commodity, and
the data representing the change in cost for the commodity represents an aggregation of the data representing the change in cost for all of the subcommodities and is calculated by aggregating the data representing the change in cost for all of the subcommodities.

18. A computer program product according to claim 16, wherein the comparative data is calculated at different levels of analysis including a first level of analysis L1, at which the commodity is defined in terms of N1 variables, and one or more additional levels of analysis L2, . . . , Ln, at which the commodity is defined in terms of N2, . . . , Nn variables, respectively, where N1 is an integer equal to or greater than 0, and for each successive level L2, . . . , Ln the number of variables N2, . . . , Nn in terms of which the commodity is defined is at least one more than the number of variables in terms of which the commodity is defined at the previous level.

19. A computer program product according to claim 15, further comprising:
a fourth computer-readable program code for causing the computer to determine whether the cost of the commodity purchased or to be purchased during the second time period represents an increase over the cost of the commodity purchased or to be purchased during the first time period and, if the cost of the commodity purchased or to be purchased during the second time period represents an increase over the cost of the commodity purchased or to be purchased during the first time period, to determine whether the increase has been authorized; and
fifth computer-readable program code for causing the computer to transmit a warning indicating that the increase has not been authorized, if the increase has been determined not to be authorized.

20. A computer program product according to claim 19,
wherein said fifth computer-readable program code is also for causing the computer to transmit a message to a vendor of the commodity requesting the vendor to transmit a rate increase proposal to a buyer of the commodity, if the increase has been determined not to be authorized, and
wherein the warning is transmitted to the buyer of the commodity.

21. A computer program product according to claim 20, wherein the rate increase proposal includes a first charge amount representing a charge by the vendor to the buyer for sale of the commodity during the second time period, based on a price charged by the vendor for the commodity during the first time period, and a second charge amount representing a charge by the vendor to the buyer for sale of the commodity during the second time period, based on a price charged by the vendor for the commodity during the second time period.
